(19) United States
(12) Patent Application Publication
(10) Pub. No.: US 2024/0284976 A1
(43) Pub. Date: Aug. 29, 2024

(54) LIQUID TRANSFER UNIT FOR ATOMIZATION CORE, AND HEATING ATOMIZATION CORE COMPRISING LIQUID TRANSFER UNIT

(71) Applicant: SHENZHEN HUACHENGDA PRECISION INDUSTRY CO. LTD., Shenzhen, Guangdong (CN)

(72) Inventor: Ping CHEN, Shenzhen (CN)

(73) Assignee: SHENZHEN HUACHENGDA PRECISION INDUSTRY CO. LTD., Shenzhen, GD (CN)

(21) Appl. No.: 18/572,801

(22) PCT Filed: Aug. 18, 2021
(86) PCT No.: PCT/CN2021/113356

§ 371 Date: Dec. 21, 2023

(51) Int. Cl. A24F 40/44; A24F 40/10; A24F 40/46; H05B 3/42

(52) U.S. Cl. CPC A24F 40/44; A24F 40/10; A24F 40/46; H05B 3/42

(57) ABSTRACT

A liquid transfer unit for an atomization core is formed by stacking multiple layers of liquid transfer cloth. At least one side of at least one layer of liquid transfer cloth has grains, such that at least two adjacent layers of liquid transfer cloth are not completely attached to each other to form micro-grooves, and the micro-grooves are connected to form a liquid chamber. The heating atomization core comprises the liquid transfer unit and a heating unit attached to the liquid transfer unit, wherein the heating unit is connected to electrode leads. This can make that liquid stored in the liquid chamber can be supplied quickly to improve the liquid transfer efficiency, thus optimizing the atomization effect.

### FIELD

The application relates to the technical field of atomization, in particular to a liquid transfer unit for an atomization core, and a heating atomization core comprising the liquid transfer unit.

### BACKGROUND

Liquid transfer cloth can be used as a liquid transfer element of electronic atomization devices, and the liquid transfer efficiency, temperature resistance and other functional factors of the liquid transfer cloth have an influence on the quality of the atomization core of the electronic atomization devices. At present, the liquid transfer efficiency of the liquid transfer cloth is adjusted, generally, by making the liquid transfer cloth from different materials, such as linen fibres, long wool fibres and composite fibres, or by making the liquid transfer cloth through different processes (the liquid transfer cloth is degreased and then woven, or the liquid transfer cloth is woven and then degreased), or by adjusting the density of the liquid transfer cloth in unit volume (the weight of the liquid transfer cloth in unit volume). However, existing liquid transfer units still have the defects of non-uniform liquid transfer, low liquid transfer rate, and untimely liquid supply during continuous operation of a heating unit, which makes the atomization effect unsatisfying, compromising the inhaling experience of users.

### SUMMARY

The technical issue to be settled by the application is to overcome the defects of non-uniform liquid transfer, low liquid transfer rate, untimely liquid supply and unsatisfying atomization effect of existing liquid transfer units by providing a liquid transfer unit with a good atomization effect and a high liquid transfer rate, and a heating atomization core comprising the liquid transfer unit.

The technical solution adopted by the application to settle the above technical issue is as follows: a liquid transfer unit for an atomization core, wherein the liquid transfer unit is formed by stacking multiple layers of liquid transfer cloth, at least one side of at least one layer of liquid transfer cloth has grains, such that at least two adjacent layers of liquid transfer cloth are not completely attached to each other to form micro-grooves, and the micro-grooves are connected to form a liquid chamber.

Further, wherein the grains on adjacent sides of the at least two adjacent layers of liquid transfer cloth are staggered to form the micro-grooves.

Further, wherein a side without grains of one layer of liquid transfer cloth is attached to a side with grains of the other layer of liquid transfer cloth to form the micro-grooves.

Further, wherein the multiple layers of liquid transfer cloth comprise at least one layer of vertical-grain liquid transfer cloth or/and at least one layer of horizontal-grain liquid transfer cloth; the vertical-grain liquid transfer cloth has grains which are configured vertically on the whole, such that micro-grooves which are vertical on the whole are formed; and the horizontal-grain liquid transfer cloth has grains which are configured horizontally on the whole, such that micro-grooves which are horizontally on the whole are formed.

Further, wherein the liquid transfer unit is formed by 1-8 layers of liquid transfer cloth, and the micro-grooves on the different layers of liquid transfer cloth are at least partially staggered on a radial direction.

Further, wherein the grains of the liquid transfer cloth are in a same direction and arranged regularly, or the grains of the liquid transfer cloth are in a same direction on the whole.

Further, wherein a height of the micro-grooves is within 0.1 mm.

Further, wherein the liquid transfer unit is a cylindrical structure or a platelike structure.

A heating atomization core, comprising the liquid transfer unit, and a heating unit attached to the liquid transfer unit, wherein the heating unit is connected to electrode leads.

Further, wherein the heating atomization core further comprises an atomization core housing, the liquid transfer unit is arranged in the atomization core housing, a fixing member for fixing the electrode leads is arranged in the atomization core housing below the liquid transfer unit, and an air inlet is formed in the fixing member.

Further, wherein a heating wire of the heating unit is correspondingly inlaid in the concave grains or between adjacent convex grains of the liquid transfer unit.

Further, wherein an area of the heating unit inlaid in the heating unit accounts for ⅓-⅔ of an area of the heating wire of the heating unit.

Further, wherein a diameter of the heating wire of the heating unit is greater than 0.2 mm, and an extension direction of the heating wire of the heating unit is identical with a direction of the grains of the liquid transfer unit on the whole.

Further, wherein a diameter of the heating wire of the heating unit is less than 0.15 mm, and an extension direction of the heating wire of the heating unit is not identical with a direction of the grains of the liquid transfer unit on the whole.

The application has the following beneficial effects: according to the liquid transfer unit for an atomization core and the heating atomization core comprising the liquid transfer unit, the liquid transfer unit for an atomization core is formed by stacking multiple layers of liquid transfer cloth, and at least one side of the liquid transfer cloth has grains, such that at least two adjacent layers of liquid transfer cloth are not completely attached to each other to form micro-grooves, and the micro-grooves are connected to form a liquid chamber for storing liquid; during the atomization process, when liquid in the innermost layer of liquid transfer cloth is consumed, a liquid chamber formed by the micro-grooves is closer than a liquid chamber outside the liquid transfer cloth, the liquid stored in the liquid chamber formed by the micro-grooves can be supplied quickly, and the liquid transfer efficiency is improved, thus optimizing the atomization effect.

### BRIEF DESCRIPTION OF THE DRAWINGS

The application will be further described below in conjunction with accompanying drawings and embodiments. In the drawings:

FIG. 1 is a sectional view of a first implementation of a liquid transfer unit for an atomization core according to Embodiment 1 of the application;

FIG. 2 is a sectional view of a second implementation of the liquid transfer unit for an atomization core according to Embodiment 1 of the application;

FIG. 3 is a sectional view of a third implementation of the liquid transfer unit for an atomization core according to Embodiment 1 of the application;

FIG. 4 is a sectional view of a fourth implementation of the liquid transfer unit for an atomization core according to Embodiment 1 of the application;

FIG. 5 is a structural view of vertical-grain liquid transfer cloth in the liquid transfer unit for an atomization core according to Embodiment 1 of the application;

FIG. 6 is a structural view of horizontal-grain liquid transfer cloth in the liquid transfer unit for an atomization core according to Embodiment 1 of the application;

FIG. 7 is a structural view of a first implementation of a heating unit in a heating atomization core according to Embodiment 2 of the application;

FIG. 8 is a structural view of a second implementation of the heating unit in the heating atomization core according to Embodiment 2 of the application;

FIG. 9 is a structural view of a third implementation of the heating unit in the heating atomization core according to Embodiment 2 of the application;

FIG. 10 is a sectional view of the heating atomization core according to Embodiment 2 of the application;

FIG. 11 is a structural view of the heating atomization core according to Embodiment 2 of the application.

### DESCRIPTION OF THE EMBODIMENTS

To gain a better understanding of the technical features, purposes and effects of the application, specific implementations of the application will be described in detail with reference to the accompanying drawings.

When one element is referred to as being “fixed to” or ‘arranged on” the other element, it may be directly or indirectly located on the other element. When one element is referred to as being “connected to” the other element, it is directly or indirectly connected to the other element.

Terms such as “upper”, “lower”, “left”, “right”, “front”, “back”, “vertical”, “horizontal”, “top”, “bottom”, “inner” and “outer” are used for indicating directions or positions based on the accompanying drawings merely for the purpose of description, and should not be construed as limitations of the technical solutions of the application. Terms such as “first” and “second” are merely for the purpose of facilitating description, and should not be construed as indicating or implying relative importance or implicitly indicating the number of technical features referred to. Unless other expressly and specifically stated, “multiple” refers to two or more.

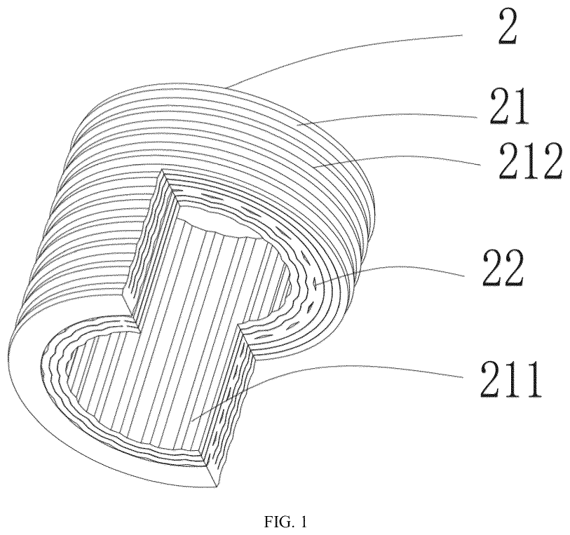

Embodiment 1: As shown in FIG. 1-FIG. 4, a liquid transfer unit 2 for an atomization core is formed by stacking multiple layers of liquid transfer cloth 21, wherein the liquid transfer cloth 21 may be made from different materials such as linen fibres, long wool-cotton fibres, spunlace non-woven fibre and composite fibres; and at least one side of at least one layer of liquid transfer cloth 21 has grains, such that at least two adjacent layers of liquid transfer cloth 21 are not completely attached to each other to form micro-grooves 22, and the micro-grooves 22 are connected to form a liquid chamber. “Stack” refers to superposition in space, that is, the liquid transfer unit 2 for an atomization core is formed by stacking liquid transfer cloth 21 layer by layer in space; and “attach” refers to seamless contact of two objects. In the application, the grains are not patterns in the traditional sense, and refer to recesses or protrusions formed on the surface of the liquid transfer cloth 21 by weaving during the textile process of the liquid transfer cloth 21, or recesses or protrusions shown on the surface of the liquid transfer cloth 21 by some technical means such as by pressing with a die, adjusting textile parameter settings, or extrusion. At least one side of at least one layer of liquid transfer cloth 21 has recesses or protrusions, so in multiple stacked layers of liquid transfer cloth 21, at least two adjacent layers of liquid transfer cloth 21 are not completely attached to each other to form multiple micro-grooves 22 due to the presence of the grains, and the multiple micro-grooves 22 are connected to form a liquid chamber for storing liquid; the micro-grooves 22 can store a large quantity of liquid in actual use, and the micro-grooves 22 are connected to form the liquid chamber; compared with traditional liquid transfer cloth 21 without micro-grooves 22, by adopting multiple layers of liquid transfer cloth 21, when liquid in the innermost layer of liquid transfer cloth 21 close to a heating unit 3 is consumed during the atomization process, liquid in the liquid transfer cloth 21 at other positions will be transferred to the innermost layer of liquid transfer cloth 21 under the capillary action; and the liquid chamber in the liquid transfer cloth 21 is closer than a liquid tank outside the liquid transfer cloth 21, so liquid stored in the liquid chamber can be supplied quickly, and the liquid transfer efficiency is improved, thus optimizing the atomization effect.

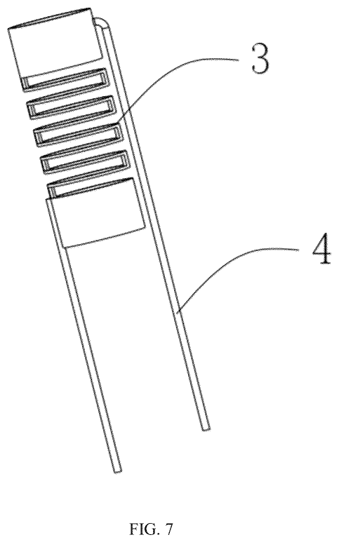

The liquid transfer cloth 21 includes at least one layer of vertical-grain liquid transfer cloth 211 or/and at least one layer of horizontal-grain liquid transfer cloth 212; as shown in FIG. 5, the vertical-grain liquid transfer cloth 211 has grains which are arranged vertically on the whole, such that micro-grooves 22 which are vertical on the whole are formed; the grains of the vertical-grain liquid transfer cloth 211 are arranged vertically on the whole, which means that most grains of the vertical-grain liquid transfer cloth 211 extend from top to bottom, that is, most micro-grooves 22 extend from top to bottom, but it is not a limitation that all the grains extend from top to bottom, the vertical-grain liquid transfer cloth 211 can also have branching grains extending outward from vertical grains, or vertical grains and horizontal grains may be arranged in a staggered manner; as shown in FIG. 6, the horizontal-grain liquid transfer cloth 212 has grains which are arranged horizontally on the whole, such that micro-grooves 22 which are horizontal on the whole are formed; and the grains of the horizontal-grain liquid transfer cloth 212 are arranged horizontally on the whole, which means that most grains of the horizontal-grain liquid transfer cloth 212 extend from left to right, but it is not a limitation that all the grains extend from left to right, the horizontal-grain liquid transfer cloth 212 can also have branching grains extending outward from vertical grains, or vertical grains and horizontal grains may be arranged in a staggered manner. The liquid transfer cloth 21 with two types of grains of the liquid transfer unit for an atomization core may be stacked in various manners: multiple layers of horizontal-grain liquid transfer cloth 212 are stacked to form the liquid transfer unit, or multiple layers of vertical-grain liquid transfer cloth 211 are stacked to form the liquid transfer unit, or multiple layers of horizontal-grain liquid transfer cloth 212 and multiple layers of vertical-grain liquid transfer cloth 211 are stacked to form the liquid transfer unit.

Because of different types of grains of the liquid transfer cloth 21, different micro-grooves 22 may be formed by arranging the liquid transfer cloth 21 in different manners: the vertical-grain liquid transfer cloth 211 and the horizontal-grain liquid transfer cloth 212 are stacked in a staggered manner, that is, one layer of vertical-grain liquid transfer cloth 211 and one layer of horizontal-grain liquid transfer cloth 212 are stacked alternately and repeatedly, in this case, the liquid transfer unit 2 with one layer of vertical micro-grooves 22 and one layer of horizontal micro-grooves 22 is formed, the micro-groove 22 on each layer are connected to form a liquid chamber, and the liquid transfer unit 2 has multiple layers of liquid chambers; or, half of the liquid transfer cloth in the liquid transfer unit 2 is vertical-grain liquid transfer cloth 211 and the other half of the liquid transfer cloth in the liquid transfer unit 2 is horizontal-grain liquid transfer cloth 212, that is, several layers of vertical-grain liquid transfer cloth 211 with the same grains are stacked together, several layers of horizontal-grain liquid transfer cloth 212 with the same grains are stacked together, and then the stacked vertical-grain liquid transfer cloth 211 and the stacked horizontal-grain liquid transfer cloth 212 are stacked together, in this case, micro-grooves 22 are formed on the contact surface of the vertical-grain liquid transfer cloth 211 and the horizontal-grain liquid transfer cloth 212, and the liquid transfer unit 2 has only one layer of micro-grooves 22, that is, one liquid chamber is formed in the middle of the liquid transfer unit 2; or, all liquid transfer cloth of the liquid transfer unit 2 is vertical-grain liquid transfer cloth 211 with different or partially different grains, and the protrusions or recesses formed on each layer of vertical-grain liquid transfer cloth 211 are staggeredly arranged when multiple layers of vertical-grain liquid transfer cloth 211 is stacked, such that radial projections of the protrusions or recesses on each layer of vertical-grain liquid transfer cloth 211 are not completely overlapped, vertical micro-grooves 22 are formed, and the degree of staggering of the protrusions or recesses has an influence on the size of the micro-grooves 22, thus having an influence on the size of the liquid chamber; or, all liquid transfer cloth of the liquid transfer unit 2 is horizontal-grain liquid transfer cloth 212 with different or partially different grains, and the protrusions or recesses formed on the multiple layers layer of horizontal-grain liquid transfer cloth 212 are staggeredly arranged when multiple layers of horizontal-grain liquid transfer cloth 212 are stacked, such that radial projections of the protrusions or recesses on each layer of horizontal-grain liquid transfer cloth 212 are not completely overlapped, horizontal micro-grooves 22 are formed, and the degree of staggering of the protrusions or recesses has an influence on the size of the micro-grooves 22, thus having an influence on the size of the liquid chamber. The application has no limitation to the size of the grains, the form of the micro-grooves 22 is not limited to the forms mentioned above, and different micro-grooves 22 may be formed by staggering the protrusions or recesses formed by the grains to different degrees, which will not be specifically described here.

The liquid transfer cloth 21 may be liquid transfer cloth 21 with grains on one side or liquid transfer cloth 21 with grains on both sides, and different micro-grooves 22 will be formed by stacking liquid transfer cloth 21 with different structures: one side without grains of one layer of liquid transfer cloth 21 is attached to one side with grains of another layer of liquid transfer cloth 21, that is, one layer of liquid transfer cloth 21 with grains on one side and one layer of liquid transfer cloth 21 without grains are stacked alternately and repeatedly, in this case, micro-grooves 22 are formed between the contact surface of every two adjacent layers of liquid transfer cloth 21, the micro-grooves 22 are connected to form a liquid chamber, and the liquid transfer unit 2 has multiple layers of liquid chambers; or, one layer of liquid transfer cloth 21 with grains on one side and one layer of liquid transfer cloth 21 with grains on both sides are stacked alternately, in this case, the side with grains of the liquid transfer cloth 21 with grains on one side is in contact with either side of one layer of liquid transfer cloth 21 with grains on both sides, the grains are staggered (the recesses or protrusions on the surfaces of the two layers of liquid transfer cloth 21 are not overlapped), and the side without grains of the liquid transfer cloth 21 with grains on one side is in contact with either side of another layer of liquid transfer cloth 21 with grains on both sides, such that multiple layers of micro-grooves 22 are formed, the micro-grooves 22 on each layer are connected to form a liquid chamber, such that the liquid transfer unit 2 has multiple layers of liquid chambers; or, half of the liquid transfer cloth 21 in the liquid transfer unit 2 is liquid transfer cloth 21 with grains on one side and the other half of the liquid transfer cloth 21 in the liquid transfer unit 2 is liquid transfer cloth 21 with grains on both sides, that is, several layers of liquid transfer cloth 21 with grains on one side are stacked together, several layers of liquid transfer cloth 21 with grains on both sides are stacked together, and then the two types of liquid transfer cloth 21 are stacked together, in this case, micro-grooves 22 are formed on the contact surface of the two types of liquid transfer cloth 21, and the liquid transfer unit 2 has only one layer of micro-grooves 22, that is, one liquid chamber is formed in the middle of the liquid transfer unit 2. The application has no limitation to the size of the grains, the form of the micro-grooves 22 is not limited to the forms mentioned above, and different micro-grooves 22 may be formed by staggering the protrusions or recesses formed by the grains to different degrees, which will not be specifically described here. The liquid transfer unit 2 includes 1-8 layers of liquid transfer cloth 21, the specific number of layers of liquid transfer cloth 21 is not limited, and the micro-grooves 22 on different layers of liquid transfer cloth 21 are at least partially staggered on the radial direction. In the application, “stagger” means that the micro-grooves 22 formed by stacking different layers of liquid transfer cloth 21 are staggered on the radial direction, and do not necessarily correspond to each other, and the degree of staggering has an influence on the size of the micro-grooves 22 (the size of the liquid chamber).

The grains on the liquid transfer cloth 21 are in the same direction and are arranged regularly, that is, the grains are repeated units and are arranged regularly; or, the grains on the liquid transfer cloth 21 are in the same direction on the whole, such that desired grains on the liquid transfer cloth 21 can be prepared by simple technical means, and the liquid transfer cloth 21 can be stacked more easily, thus reducing production costs.

The height of the micro-grooves 22 in the liquid transfer unit 22 is within 0.1 mm, the size of the liquid chamber can be controlled by controlling the height of the micro-grooves 22, the liquid transfer cloth 21 will be saturated when absorbing liquid to some extent and will be oversaturated if the size of the liquid chamber is too large, and at this moment, liquid will overflow from the liquid transfer unit 2, thus compromising the atomization effect.

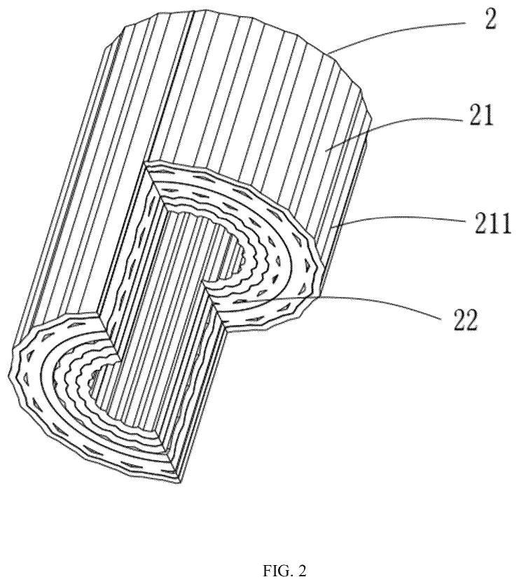

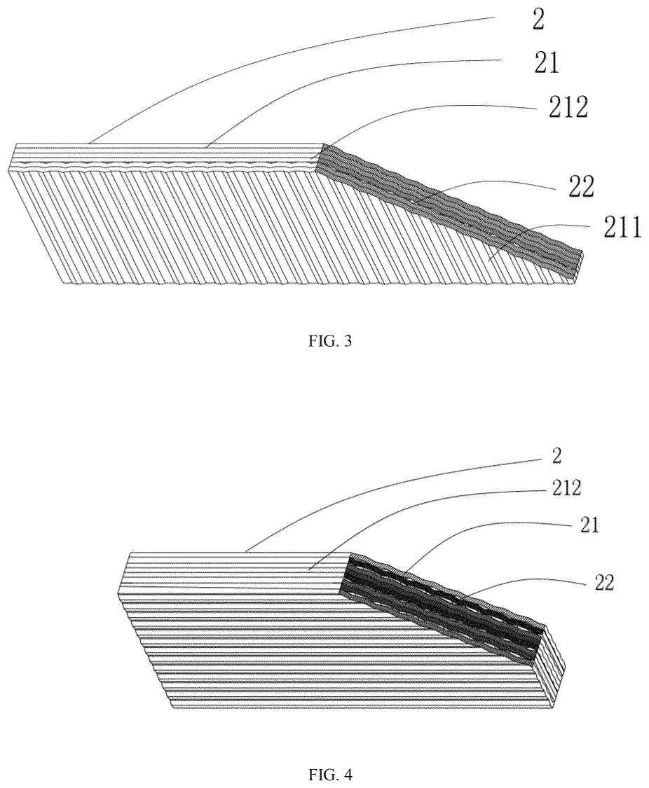

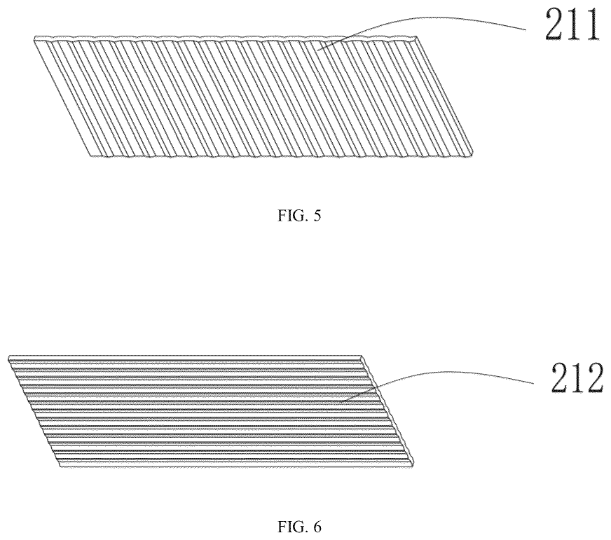

As shown in FIG. 1-FIG. 2, the liquid transfer unit 2 is a cylindrical structure; or, as shown in FIG. 3-FIG. 4, the liquid transfer unit 2 is a platelike structure. According to the actual structure of an atomization core, the liquid transfer unit 2 may be a cylindrical structure or a platelike structure, and the actual shape of the liquid transfer unit 2 may be changed as actually needed.

Due to the fact that the micro-grooves may be in various forms, the liquid chambers may also be in various forms. The liquid chamber is regularly arranged on the contact surface of each layer of liquid transfer cloth or the liquid chamber is arranged every one layer of liquid transfer cloth, and the liquid chamber is vertical or horizontal, which will not be detailed here.

Embodiment 1-1: As shown in FIG. 1, the liquid transfer unit 2 is a cylindrical structurer and is formed by stacking horizontal-grain liquid transfer cloth 212 and vertical-grain liquid transfer cloth 211, each accounting for half, wherein the vertical-grain liquid transfer cloth 211 is located on an inner side of the liquid transfer unit 2, the horizontal-grain liquid transfer cloth 212 is located on an outer side of the liquid transfer unit 2, micro-grooves 22 are formed on the contact surface of the horizontal-grain liquid transfer cloth 212 and the vertical-grain liquid transfer cloth 211, the micro-grooves 22 are connected to form a liquid chamber, and the liquid transfer unit 2 has one layer of liquid chamber.

Embodiment 1-2: As shown in FIG. 2, the liquid transfer unit 2 is a cylindrical structure and is formed by stacking multiple layers of vertical-grain liquid transfer cloth 211, and vertical grains on the multiple layers of liquid transfer cloth 211 are staggered, that is, recesses or protrusions on the surfaces of two adjacent layers of liquid transfer cloth 21 are not overlapped, such that micro-grooves 22 are formed, the micro-grooves 22 on each layer are connected to form a liquid chamber, and the liquid transfer unit 2 has multiple layers of liquid chambers.

Embodiment 1-3; As shown in FIG. 3, the liquid transfer unit 2 is a platelike structure and is formed by stacking horizontal-grain liquid transfer cloth 212 and vertical-grain liquid transfer cloth 211, each accounting for half, wherein grains on the vertical-grain liquid transfer cloth 211 are identical, the grains on the horizontal-grain liquid transfer cloth 212 are identical, micro-grooves 22 are formed on the contact surface of the innermost layer of horizontal-grain liquid transfer cloth 212 and the innermost layer of vertical-grain liquid transfer cloth 211, the micro-grooves 22 are connected to form a liquid chamber, and the liquid transfer unit 2 has one layer of liquid chamber.

Embodiment 1-4: As shown in FIG. 4, the liquid transfer unit 2 is a platelike structure and is formed by stacking multiple layers of horizontal-grain liquid transfer cloth 212, and horizontal grains on each layer of horizontal-grain liquid transfer cloth 212 are staggered, that is, the recesses or protrusions on the surfaces of two adjacent layers of liquid transfer cloth 21 are not overlapped, such that micro-grooves 22 are formed, the micro-grooves 22 on each layer are connected to form a liquid chamber, and the liquid transfer unit 2 has multiple layers of liquid chambers.

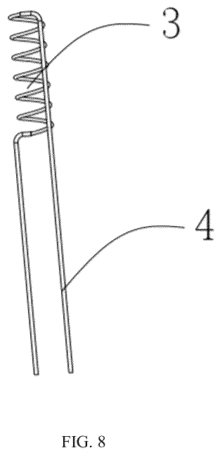

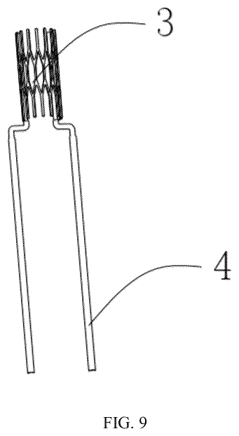

Embodiment 2: As shown in FIG. 7-FIG. 11, a heating atomization core includes the liquid transfer unit 2 in Embodiment 1, and a heating unit 3 attached to the liquid transfer unit 2, wherein the heating unit 3 is connected to electrode leads 4. When the heating atomization core is used, the electrode leads 4 supply power to the heating unit 3, then the heating unit 3 generates heat to atomize cigarette liquid in the liquid transfer unit 2 into steam, and the steam is finally inhaled by users.

As shown in FIG. 7-FIG. 9, the heating unit 3 includes a heating wire in the middle and the electrode leads 4 connected to two ends, and is typically made from alloy with a high electrical resistivity, such as stainless steel alloy, nickel-chromium alloy, ferrum-chromium-aluminum alloy or nickel-ferrum alloy. The heating unit 3 is a cylindrical heating unit 3 rolled from a planar meshed heating unit 3, or a heating unit 3 made of a spiral wire, or a heating unit 3 formed by cutting and hollowing-out a metal tube, and the direction of the heating wire includes three types, the heating wire of the heating unit 3 extends horizontally on the whole, or extends vertically on the whole, or is a meshed structure.

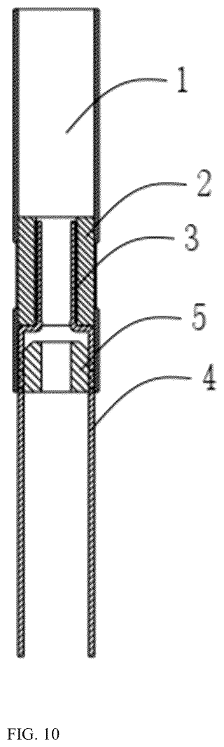

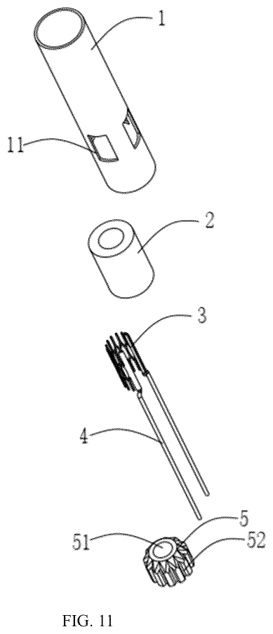

Embodiment 2-1: As shown in FIG. 10-FIG. 11, the heating atomization core further includes an atomization core housing 1, wherein the liquid transfer unit 2 is configured in the atomization core housing 1, a fixing member 5 for fixing the electrode is configured in the atomization core housing 1 below the liquid transfer unit 2, and an air hole 51 is formed in the fixing member 5. The heating unit 3 is attached into the liquid transfer unit 2, the liquid transfer unit 2 is configured in the atomization core housing, both the liquid transfer unit 2 and the heating unit 3 are restrained from the atomization core housing 1 and fixed in the atomization core housing 1, and the electrode leads 4 are fixed by the fixing member 5, so the problem that the heating wire of the heating unit 3 shakes along with the electrode leads 4 when the electrode leads 4 are stressed is solved, and poor contact between the liquid transfer unit 2 and the heating unit 3 is avoided; liquid transfer holes 11 are formed in a side wall of the atomization core housing 1, and the contact area between liquid and the liquid transfer unit 2 can be controlled by controlling the size of the liquid transfer holes 11; and when the heating atomization core is used, liquid enters the liquid transfer unit 2 through the liquid transfer holes 11 in the side wall of the atomization core housing 1 and then flows into the liquid transfer unit 2, the electrode leads 4 supply power to the heating unit 3, the heating unit 3 generates heat to atomize cigarette liquid in the liquid transfer unit 2 into steam, and the steam is brought into an air passage by air flowing in through the air inlet 51 and is finally inhaled by users.

As shown in FIG. 11, locating slots 52 are formed in the periphery of the fixing member 5, and the electrode leads 4 are clamped in the locating slots 52 to be fixed. The cross-section of the locating slots 52 is arc-shaped, U-shaped, V-shaped, square, or the like, and is preferably V-shaped, the opening of V-shaped locating slots 52 is large, such that the electrode leads 4 can be inserted into the locating slots 52 easily and can be completely clamped and fixed in the locating slots 52. At least one locating slot 52 is formed in the periphery of the fixing member 5. In a case where one locating slot 52 is formed in the periphery of the fixing member 5, the two electrode leads 4 are fixed in the same locating slot 52. In a case of two locating slots 52 are formed in the periphery of the fixing member 5, the two electrode leads 4 are clamped in different locating slots 52. In a case were multiple locating slots 52 are formed in the periphery of the fixing member 5, the multiple locating slots 52 are regularly distributed on the periphery of the fixing member 5, and the two electrode leads 4 are clamped in any two locating slots 52. In another implementation, the fixing member 5 is provided with fixing through-holes, and the electrode leads 4 penetrate through the fixing holes to be fixed.

Embodiment 2-2: The heating wire of the heating unit 3 is correspondingly inlaid in concave grains or between adjacent convex grains of the liquid transfer unit 2, wherein the heating wire of the heating unit 3 is entirely inlaid in the concave grains or between adjacent convex grains of the liquid transfer unit 2, or the heating wire of the heating unit 3 is partially inlaid in the concave grains or between adjacent convex grains of the liquid transfer unit 2; when the heating wire of the heating unit 3 is entirely inlaid in the concave grains or between adjacent convex grains of the liquid transfer unit 2, the heating wire is the same as the direction of the grains on the liquid transfer cloth 21. The area of the heating unit 3 inlaid in the liquid transfer unit 2 is not the more the better; if the area of the heating unit 3 inlaid in the liquid transfer unit 2 is too large, the entire heating unit 3 will be soaked in liquid in the liquid transfer unit 2, steam produced during the atomization process will be completely wrapped in liquid and is likely to gush from liquid. Preferably, the area of the heating unit 3 inlaid in the heating unit accounts for ⅓-⅔ of the total area of the heating wire of the heating unit 3, so steam gushing and dry burning are unlikely to occur, and heat generated by the heating unit 3 can be used for atomization to the maximum extent to improve the atomization effect, thus improving the inhaling experience of users.

Embodiment 2-3: The diameter of the heating wire of the heating unit 3 and whether the extension direction of the heating wire is identical with the direction of the grains of the liquid transfer unit 2 both have some influence on the atomization effect of the atomization core; after the liquid transfer unit 2 is designed and machined, horizontal grains and/or vertical grains are formed on the liquid transfer unit 2, that is, horizontal micro-grooves 22 and/or vertical micro-grooves 22 are formed on the liquid transfer unit 2, and the direction of the grains is of great importance when the liquid transfer unit 2 is attached to the heating unit 3; when the heating unit 3 extending horizontally is attached to the liquid transfer cloth 21 with vertical grains, the area of the heating wire of the heating unit 3 inlaid in the liquid transfer unit 2 is small; and when the heating unit 3 extending horizontally is attached to the liquid transfer unit 2 with horizontal grains, the area of the heating wire of the heating unit 3 inlaid in liquid transfer cotton is large. When the diameter of the heating wire of the heating unit 3 is large such as 0.2 mm or over, it is better that the extension direction of the heating wire of the heating unit 3 is identical with the direction of the grains of the liquid transfer unit 2 on the whole, for example, if the heating wire of the heating unit 3 extends horizontally, the grains of the liquid transfer unit 2 are horizontal, that is, the micro-grooves 22 are horizontal micro-grooves 22, such that the contact area between the heating unit 3 and the liquid transfer unit 2 is large, and the atomization area is enlarged. When the diameter of the heating wire of the heating unit 3 is small such as less than 0.15 mm, it is better that the extension direction of the heating wire of the heating unit 3 is not identical with the direction of the grains of the liquid transfer unit 2 on the whole, for example, if the heating wire of the heating unit 3 extends horizontally, the grains of the liquid transfer unit 2 are vertical, that is, the micro-grooves 22 are vertical micro-grooves, such that the atomization effect of the atomization core is better.

1. A liquid transfer unit for an atomization core, wherein the liquid transfer unit is formed by stacking multiple layers of liquid transfer cloth (21), at least one side of at least one layer of liquid transfer cloth (21) has grains, such that at least two adjacent layers of liquid transfer cloth (21) are not completely attached to each other to form micro-grooves (22), and the micro-grooves (22) are connected to form a liquid chamber.

2. The liquid transfer unit for an atomization core according to claim 1, wherein the grains on adjacent sides of the at least two adjacent layers of liquid transfer cloth (21) are staggered to form the micro-grooves (22).

3. The liquid transfer unit for an atomization core according to claim 1, wherein a side without grains of one layer of liquid transfer cloth (21) is attached to a side with grains of the other layer of liquid transfer cloth (21) to form the micro-grooves (22).

4. The liquid transfer unit for an atomization core according to claim 1, wherein the multiple layers of liquid transfer cloth (21) comprise at least two layers of vertical-grain liquid transfer cloth (211), or comprise at least two layers of horizontal-grain liquid transfer cloth (212), or comprise at least one layer of vertical-grain liquid transfer cloth (211) and at least one layer of horizontal-grain liquid transfer cloth (212);
wherein when the multiple layers of liquid transfer cloth (21) comprise vertical-grain liquid transfer cloth (211), the vertical-grain liquid transfer cloth (211) has grains which are configured vertically on the whole, such that micro-grooves (22) which are vertical on the whole are formed; and when the multiple layers of liquid transfer cloth (21) comprise horizontal-grain liquid transfer cloth (212), the horizontal-grain liquid transfer cloth (212) has grains which are configured horizontally on the whole, such that micro-grooves (22) which are horizontally on the whole are formed.

5. The liquid transfer unit for an atomization core according to claim 4, wherein the liquid transfer unit is formed by 2-8 layers of liquid transfer cloth (21), and the micro-grooves (22) on the different layers of liquid transfer cloth (21) are at least partially staggered on a radial direction.

6. The liquid transfer unit for an atomization core according to claim 1, wherein the grains of the liquid transfer cloth (21) are in a same direction and arranged regularly, or the grains of the liquid transfer cloth (21) are in a same direction on the whole.

7. The liquid transfer unit for an atomization core according to claim 1, wherein a height of the micro-grooves (22) is within 0.1 mm.

8. The liquid transfer unit for an atomization core according to claim 1, wherein the liquid transfer unit (2) is a cylindrical structure or a platelike structure.

9. A heating atomization core, comprising the liquid transfer unit (2) according to claim 1, and a heating unit (3) attached to the liquid transfer unit (2), wherein the heating unit (3) is connected to electrode leads (4).

10. The heating atomization core according to claim 9, wherein the heating atomization core further comprises an atomization core housing (1), the liquid transfer unit (2) is arranged in the atomization core housing (1), a fixing member (5) for fixing the electrode leads (4) is arranged in the atomization core housing (1) below the liquid transfer unit (2), and an air inlet (51) is formed in the fixing member (5).

11. The heating atomization core according to claim 9, wherein a heating wire of the heating unit (3) is correspondingly inlaid in the concave grains or between adjacent convex grains of the liquid transfer unit (2).

12. The heating atomization core according to claim 11, wherein an area of the heating unit (3) inlaid in the liquid transfer unit (2) accounts for ⅓-⅔ of an area of the heating wire of the heating unit (3).

13. The heating atomization core according to claim 9, wherein a diameter of the heating wire of the heating unit (3) is greater than 0.2 mm, and an extension direction of the heating wire of the heating unit (3) is identical with a direction of the grains of the liquid transfer unit (2) on the whole.

14. The heating atomization core according to claim 9, wherein a diameter of the heating wire of the heating unit (3) is less than 0.15 mm, and an extension direction of the heating wire of the heating unit (3) is not identical with a direction of the grains of the liquid transfer unit (2) on the whole.

15. The heating atomization core according to claim 9, wherein the grains on adjacent sides of the at least two adjacent layers of liquid transfer cloth (21) are staggered to form the micro-grooves (22).

16. The heating atomization core according to claim 9, wherein a side without grains of one layer of liquid transfer cloth (21) is attached to a side with grains of the other layer of liquid transfer cloth (21) to form the micro-grooves (22).

17. The heating atomization core according to claim 9, wherein the multiple layers of liquid transfer cloth (21) comprise at least two layers of vertical-grain liquid transfer cloth (211), or comprise at least two layers of horizontal-grain liquid transfer cloth (212), or comprise at least one layer of vertical-grain liquid transfer cloth (211) and at least one layer of horizontal-grain liquid transfer cloth (212);
wherein when the multiple layers of liquid transfer cloth (21) comprise vertical-grain liquid transfer cloth (211), the vertical-grain liquid transfer cloth (211) has grains which are configured vertically on the whole, such that micro-grooves (22) which are vertical on the whole are formed; and when the multiple layers of liquid transfer cloth (21) comprise horizontal-grain liquid transfer cloth (212), the horizontal-grain liquid transfer cloth (212) has grains which are configured horizontally on the whole, such that micro-grooves (22) which are horizontally on the whole are formed.

18. The heating atomization core according to claim 17, wherein the liquid transfer unit is formed by 2-8 layers of liquid transfer cloth (21), and the micro-grooves (22) on the different layers of liquid transfer cloth (21) are at least partially staggered on a radial direction.

19. The heating atomization core according to claim 9, wherein a height of the micro-grooves (22) is within 0.1 mm.

20. The heating atomization core according to claim 9, wherein the liquid transfer unit (2) is a cylindrical structure or a platelike structure.
